(19) United States
(12) Patent Application Publication
(10) Pub. No.: US 2025/0159393 A1
(43) Pub. Date: May 15, 2025

(54) PORTABLE MAGNETIC WIRELESS SPEAKER SYSTEM

(71) Applicant: Traci Kimberly Young, Galion, OH (US)

(72) Inventor: Traci Kimberly Young, Galion, OH (US)

(21) Appl. No.: 18/732,791

(22) Filed: Jun. 4, 2024

Related U.S. Application Data
(60) Provisional application No. 63/598,626, filed on Nov. 14, 2023.

(51) Int. Cl. H04R 1/02; H04R 3/00

(52) U.S. Cl. CPC H04R 1/026; H04R 1/028; H04R 3/00; H04R 2420/07

(57) ABSTRACT

An audio output device including at least one speaker for outputting audio. The audio output device includes a magnetic base integrally coupled to the at least one speaker. The audio output device includes a controller electrically coupled to at least one speaker. The controller receives audio data and converts the audio data into electrical signals for transmission to at least one speaker.

### CROSS-REFERENCE TO RELATED APPLICATIONS

This application claims the benefit of priority of U.S. provisional application No. 63/598,626, filed Nov. 14, 2023, titled “Portable Magnetic Wireless Speaker System” the entire contents of which are herein incorporated by reference.

### FIELD

The present invention relates to speakers and other audio devices and, more particularly, to wireless speakers.

### BACKGROUND

A portable wireless speaker is a compact audio device that allows users to play music or other audio content from various sources such as mobile phones without the need for wired connections. Portable wireless speakers have gained popularity for their convenience and versatility. Portable wireless speakers allow users to enjoy music and audio content virtually anywhere, whether at home, during outdoor activities, or while traveling. A portable wireless speaker, however, is not compatible with all situations. The portable wireless speaker typically requires the user to hold the speaker or to place the speaker on a flat, stationary surface.

As can be seen, there is a need for additional flexibility in portable wireless speaker design.

### SUMMARY

In one aspect of the present disclosure, an audio output device including at least one speaker for outputting audio. The audio output device includes a magnetic base integrally coupled to the at least one speaker. The audio output device includes a controller electrically coupled to at least one speaker. The controller receives audio data and converts the audio data into electrical signals for transmission to at least one speaker.

### BRIEF DESCRIPTION OF THE DRAWINGS

FIG. 1 is a diagram of a portable magnetic wireless speaker system, according to aspects of the present disclosure; and

FIG. 2 is a block diagram of electronics for the portable magnetic wireless speaker system of FIG. 1, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

Broadly, an embodiment of the present invention provides a system and process for a portable magnetic wireless speaker system. The strong magnetic base will hold speakers in place on a metallic surface. For example, the portable magnetic wireless speaker system can be placed on either side of a motorcycle fuel tank, or any magnetic surface to allow for sound without installing bulky speaker kits. As such, the portable magnetic wireless speaker system can output music on a motorcycle not equipped with a stereo. The portable magnetic wireless speaker system can solve where a speaker can be placed without falling.

In embodiments, the speaker includes hardware and/or software that allows multiple speakers to be paired and operated and a sound system. For example, the speaker can include Bluetooth capabilities, dual pairing, and magnetic properties are necessary. By allowing dual pairing, the portable magnetic wireless speaker system can allow more than one speaker to be placed for better sound on a motorcycle.

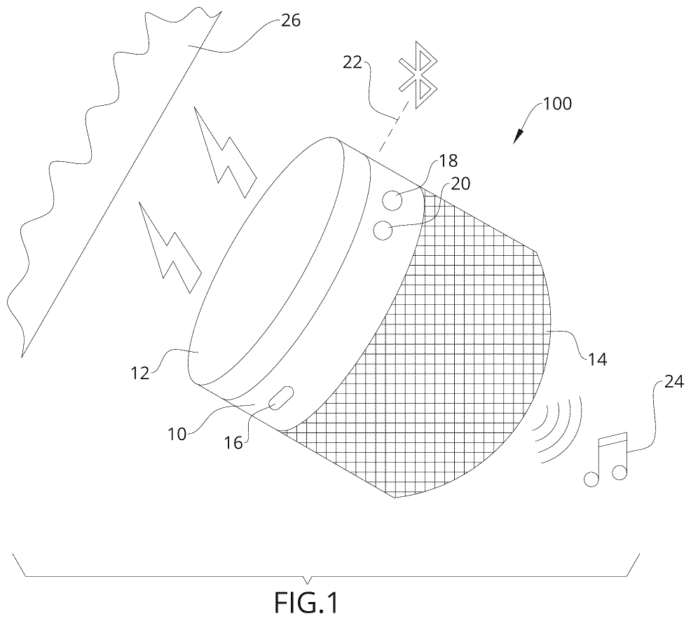

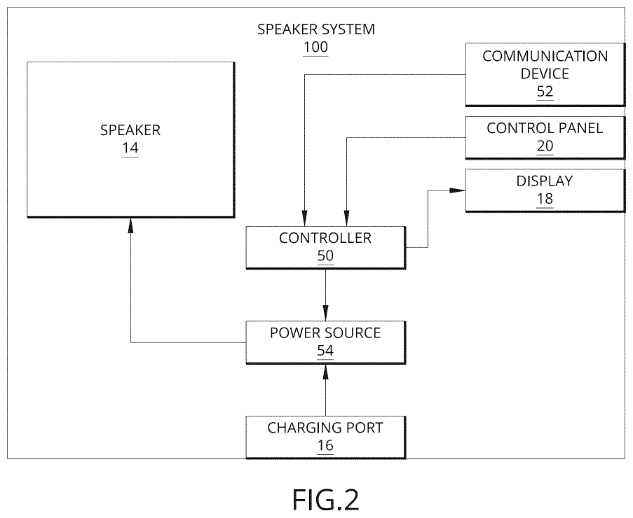

Referring now to FIGS. 1 and 2, FIG. 1 illustrates a portable magnetic wireless speaker system (“speaker system”) 100, according to aspects of the present disclosure. While FIG. 1 illustrates examples of components of the speaker system 100, additional components can be added and existing components can be removed and/or modified.

As illustrated in FIG. 1, the speaker system 100 includes a body 10 and a magnetic base 12. In some embodiments, the body 10 and the magnetic base 12 can be integrally constructed as a single unit. For example, the magnetic base 12 can be permanently affixed to a bottom surface of the body 10. The magnetic base 12 allows the speaker system 100 to be removably fixed to a surface, e.g., surface 26, with magnetic properties. For example, the speaker system 100 can be affixed to a portion of a motorcycle, such as the fuel tank. The magnetic base 12 can be constructed of any magnetic material. For example, the magnetic base 12 can be constructed of Iron (Fe), Neodymium (NdFeB), Samarium-Cobalt (SmCo), Aluminum, Nickel, Cobalt, Ferrite (Ceramic), and combinations thereof.

The body 10 can include a speaker 14 and input/output interfaces for interacting with the speaker 14. In embodiments, the input/output interfaces can include a charging port 16, a display 18 (e.g., power light, pairing indicator light, etc.), and a control panel 20 (e.g., power button, pairing button, etc.) In some embodiments, the display 18 and control panel 20 can be incorporated in a single interface. The speaker 14 can be any type of audio device that outputs or play auditory sounds, for example, music 24. In one example, the speaker 14 can be a wireless speaker that receives audio data wireless using a wireless signal 22, e.g., Bluetooth. The speaker 14 can include hardware and/or software that allows multiple speakers to be paired and operated and a sound system. For example, the speaker can include Bluetooth capabilities, dual pairing, and magnetic properties are necessary.

The speaker system 100 can be included the necessary electronic hardware to operate the speaker 14. FIG. 2 illustrates various electrical components that can be included in the speaker system 100. The speaker system 100 can include a controller 50 and a power source 54. The power source 54 is coupled to the speaker 14 and supplies electrical energy to the speaker 14 (and other electrical components). The power source 54 can be any portable power source, such as a rechargeable battery. The speaker system 100 can include the charging port 16 that allows an external power source to be coupled to the power source 54 for charging.

The controller 50 can operate to control the output of audio from the speaker 14. The controller 50 can include any necessary digital and/or analog electrical components to control the operation of the speaker system 100. The speaker system 100 can also include the control panel 20 and a display 18. As discussed above, the control panel 20 can include one or more input devices, e.g., switches, buttons, knobs, etc., that allow a user to control the operation of the speaker system 100. For example, the control panel 20 can include one or more input devices that will enable a user to activate the speaker system 100. The control panel 20 delivers the input signals to the controller 50 to control the operation of the speaker system 100.

The display 18 can include one or more output devices, e.g., light emitting device (LED) lights, display screen, audio output devices, etc., that communicate the operation status of the speaker system 100. The controller 50 can provide output signals to the display 18 to provide the operational status of the speaker system 100 to a user.

The speaker system 100 can also include a communication device 52 that is coupled to the controller 50. The communication device 52 can allow one or more user devices, e.g., mobile phones, laptop computers, desktop computers, tablet computers, etc., to communicate with the speaker system 100 and control the operation of the speaker system 100. The communication device 52 allows a user to establish a wireless connection to the speaker system 100. For example, the communication device 52 can include, for example, a networking chip, one or more antennas, and/or one or more communication ports. The communication device 52 can generate radio frequency (RF) signals and transmit the RF signals via one or more of the antennas. The communication device can receive and/or translate the RF signals. The communication device can transceive the RF signals. The RF signals can be broadcast and/or received by the antennas. The communication device 52 can include hardware and/or software for generating and communicating signals over a direct and/or indirect network communication link. For example, the communication device 52 can include an RF antenna with Bluetooth™ programming installed on a processor, such as the processing component, coupled to the antenna. In another example, the communication component can include an RF antenna and programming installed on a processor, such as the processing device, for communicating over a wireless fidelity (“WiFi”) WiFi and/or cellular network.

In some embodiments, the controller 50 can include one or more processing devices. The processing devices can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and the like. As used herein, “processor,” “processing component,” “processing device,” and/or “processing unit” can be used generically to refer to any or all of the aforementioned specific devices, elements, and/or features of the processing device.

In some embodiments, the controller 50 can include one or more memory devices. The memory devices can be and/or include one or more computerized storage media capable of storing electronic data temporarily, semi-permanently, or permanently. The memory devices can be or include a computer processing unit register, a cache memory, a magnetic disk, an optical disk, a solid-state drive, and the like. The memory devices can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory devices.

In some embodiments, the control panel 20 and/or display 18 can be embodied in a user interface. The user interface can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The user interface can include an acoustic element such as a speaker, a microphone, and so forth. The user interface can include a button, a switch, a keyboard, a touch-sensitive surface, a touchscreen, a camera, a fingerprint scanner, and so forth. The touchscreen can include a resistive touchscreen, a capacitive touchscreen, and so forth.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. An audio output device, comprising:
at least one speaker for outputting audio;
a magnetic base integrally coupled to the at least one speaker; and
a controller electrically coupled to the at least one speaker, wherein the controller receives audio data and converts the audio data into electrical signals for transmission to the at least one speaker.

2. The audio output device of claim 1, further comprising:
at least one communication device electrically coupled to the controller, wherein the at least one communication device communicates with one or more remote electronic devices to receive audio data for conversion to the audio by the at least one speaker.

3. The audio output device of claim 2, wherein the at least one communication device comprises a Bluetooth device.

4. The audio output device of claim 1, further comprising:
at least one control panel electrically coupled to the controller; and
at least one display electrically coupled to the controller.

5. The audio output device of claim 4, wherein the at least one control panel comprises a power button or a communication pairing button.

6. The audio output device of claim 4, wherein the at least one display comprises a light emitting diode.

7. The audio output device of claim 1, wherein the magnetic base comprises at least one magnet.

8. The audio output device of claim 1, wherein the at least one magnet comprises one or more of Iron (Fe), Neodymium (NdFeB), Samarium-Cobalt (SmCo), Aluminum, Nickel, Cobalt, or Ferrite.
